(19) United States
(12) Patent Application Publication
(10) Pub. No.: US 2016/0083493 A1
(43) Pub. Date: Mar. 24, 2016

(54) CONCRETE ADMIXTURES

(71) Applicant: Technische Universitat München, Munich (DE)

(72) Inventors: Johann Plank, Munich (DE); Alex Lange, Fürholzen (DE)

(21) Appl. No.: 14/380,152

(22) PCT Filed: Mar. 28, 2013
(86) PCT No.: PCT/EP2013/000953

§ 371 Date: Aug. 21, 2014

(30) Foreign Application Priority Data
Mar. 30, 2012 (EP) 12002354.4

(51) Int. Cl. C08F 222/06; C08K 3/34; C08L 33/14; C08F 222/10

(52) U.S. Cl. CPC C08F 222/06; C08F 222/1006; C08K 3/346; C08L 33/14

(57) ABSTRACT

The present invention relates to a copolymer which is obviously by polymerizing monomer components comprising: (a) a compound represented by formula (A1): Y—B-0-(A-0)ₘR²(A1) wherein Y represents an alkenyl group containing two or more carbon atoms, B represents a C₂₋₁₈ oxyalkylene group; R² represents a hydrogen atom or a C₁₋₃₀ hydrocarbon group and m represents an integer of from 0 to 300; and/or an addition product obtained by the addition of 0-8 moles of any alkylene oxide having 2 to 4 carbon atoms to one equivalent of amino residues in polyamide polyamine obtained by condensation of 1.0 moles of apolyalkylene polyamine, 0.8-0.95 mole of a dibasic acid or an ester of the dibasic acid with a lower alcohol having 1 to 4 carbon atoms, and 0.05-0.18 mole of acrylic acid or methacrylic acid, or an ester of acrylic acid or methacrylic acid with a lower alcohol having 1 to 4 carbon atoms; (b) an unsaturated monocarboxylic acid or a salt thereof, or an unsaturated dicarboxylic carboxylic acid or a salt thereof or an anyhydride of an unsaturated cicarboxylic acid; and (c) a compound represent by formula (C): R¹¹R¹²C═CR¹³—(CR³R⁴)ₙ—O—CO—CH═CH—COOR¹⁶(C) wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2 and to a dispersant inorganic binders (such as cement) comprising said copolymer; and, when m is 0, esterifying the resulting copolymer with a compound of formula HO-(A-O—)₂R², wherein R² represents a hydrogen atom or a C₁₋₃₀ hydrocarbon group and z represents an integer of from 1 to 300.

The present invention relates to concrete admixtures (additives), especially to polycarboxylate (PCE) superplasticizers.

The invention of superplasticizers back in 1962 presents a significant advance in concrete technology. Application of these admixtures which are effective at low dosages (as low as 0.02% by weight of cement) allows to produce a highly durable concrete, yet with excellent workability [Ramachandran V. S., Malhotra V. M., Jolicoeur C., Spiratos N., “Superplasticizers: Properties and Applications in Concrete”, CANMET Publication, Canadian Government Publishing Centre Supply & Services Canada, ISBN 066017393X, 1998]. Owed to their unique effects, it is possible to formulate self-compacting [Okamura, H., Ouchi, M., “Self-Compacting Concrete”, Journal of Advanced Concrete Technology, V. 1, 2003, pp. 5-15] and ultra-high strength concrete [Kinoshita M., Suzuki T., Soeda K., Nawa T., “Properties of methacrylic water-soluble polymer as a superplasticizer for ultra high-strength concrete”, Malhotra V. M. Ed. 5^{th} CANMET/ACI International Conference on Superplasticizers and Other Chemical Admixtures in Concrete, Rome/Italy, American Concrete Institute, SP-173, 1997, pp. 143-162]. These modern advanced concretes allow to build structures such as long-span bridges, high rise buildings etc. which were impossible before superplasticizers became known.

Nowadays, superplasticizers can be categorized into four chemically distinctly different classes: polycondensates; polycarboxylates; ‘small molecules’ and biopolymers.

Polycondensates represent the first type of superplasticizer. From this group, β-naphthalenesulfonate-formaldehyde (BNS) constitutes by far the most widely used type [Hattori K., Yamakawa C., Suzue S., Azuma T., Imamura T., Ejiri Y., “Flowing concrete”, Review of General Meeting, Technical Session—Cement Association of Japan, V. 30, 1976, 153-154]. Additionally, melamine-formaldehyde-sulfite (PMS) [Aignesberger, A.; Bornmann, P.; Rosenbauer, H.-G., Theissig, H., DE 2,359,291, 1974, SKW Trostberg AG], acetone-formaldehyde-sulfite (AFS) [Aignesberger A., Plank J., DE 3,144,673, 1981; Plank J., Aignesberger A., DE 3,344,291, 1981, SKW Trostberg AG] and sulfanilic acid-phenol-formaldehyde (SPF) [Pei, M., Wang, D., Hu, X., Xu, D., “Synthesis of sodium sulfanilate-phenol-formaldehyde condensate and its application as a superplasticizer in concrete”, Cement and Concrete Research, V. 30, 2000, pp. 1841-1845] polycondensates are utilized in specific applications. Main advantages of polycondensate-type superplasticizers include relatively simple preparation from commonly available raw materials, robust performance with cements of variable compositions and high tolerance to contaminants occasionally occurring in cement such as e.g. clay and silt.

In 1981, polycarboxylate comb polymers were introduced as a new class of superplasticizers [JP S59-018338]. Their structural characteristic is an anionic polymer backbone which holds lateral graft chains. These side chains instigate a steric hindrance effect between the cement particles suspended in water [Uchikawa H., Hanehara S., Sawaki D., “The role of steric repulsive force in the dispersion of cement particles in fresh paste prepared with organic admixture”, Cement and Concrete Research, V. 27, 1997, pp. 37-50]. Through this unique mechanism, PCE superplasticizers exhibit superior dispersing force compared to polycondensates. Because of their highly tunable chemical and molecular structure, PCEs can accommodate many different purposes such as providing long slump retention (2+hours), effectiveness at ultra-low water-to-cement ratios (w/c<0.25), or the so-called ‘Sarato-kan’ effect whereby concrete rapidly flows to its final spread (or slump) instead of creeping slowly. Consequently, a great diversity of chemically different PCE products is on the market which includes:

MPEG-type PCEs, made from ω-methoxypoly(ethylene glycol) methacrylate ester (MPEG-MA), either by aqueous free radical copolymerisation [Plank J., Pollmann K., Zouaoui N., Andres P. R., Schaefer C., “Synthesis and performance of methacrylic ester, based polycarboxylate superplasticizers possessing hydroxy terminated polyethylene glycol) side chains”, Cement and Concrete Research, V. 38, 2008, pp. 1210-1216.] or by esterification/transesterification reaction [FR 2 776 285]. APEG-type PCEs, made from α-allyl-ω-methoxy or ω-hydroxy poly(ethylene glycol) (APEG) ether and maleic anhydride as key monomers via radical copolymerisation either in bulk⁻or in aqueous solution [EP 0 291 073]. Comonomers such as styrene are frequently used as so-called spacer molecules to adjust the conformational flexibility of the trunk chain. This method provides polymers with pronounced stiffness or more coiled conformation and hence modifies their adsorption behaviour.

VPEG-type PCEs, based on vinyl ethers such as 4-hydroxy butyl-poly(ethylene glycol) vinyl ether which is preferably co-polymerised at low temperatures (<30° C.) with e.g. maleic anhydride [EP 0 736 553].

IPEG-type PCEs (sometimes also referred to as TPEG-type PCE) made from isoprenyl oxy poly(ethylene glycol) macromonomers by copolymerisation with acrylic acid, for example [U.S. Pat. No. 6,727,315]. Recently, this type of PCE has become very popular because of its easy preparation from versatile raw materials.

HPEG-type PCEs utilize α-methallyl-ω-methoxy or ω-hydroxy poly(ethylene glycol) ether as macromonomer [DE 100 48 139] (In some company literatures, the term HPEG-type PCE is applied to MPEG-type PCEs where the poly(ethylene glycol) side chain is hydroxy terminated instead of methoxy).

XPEG-type PCEs represent slightly crosslinked PCEs; they are made from monomers which possess two reactive double bonds (e.g. diesters) or diols capable of forming two ester bonds and thus can provide some degree of crosslinking [U.S. Pat. No. 5,476,885].

PAAM-type PCEs: these zwitter-ionic PCEs possess polyamidoamine (PAAM) side chains; this structural feature distinguishes them fundamentally from all other PCEs which contain PEO/PPO side chains. The PAAM-type PCE is said to fluidify cement at w/c ratios as low as 0.12 [WO 00/39045].

It has been the object of the present invention to improve the properties of the polycarboxylate (PCE) superplasticizers.

The present invention provides a copolymer which is obtainable by polymerizing monomer components comprising:
(a) a compound represented by formula (A1):

Y—B—O-(A-O—)ₘR² (A1)
wherein Y represents an alkenyl group containing two or more carbon atoms, B represents a bond or a CO group; A-O independently represents a C₂₋₁₈ oxyalkylene group; R² represents a hydrogen atom or a C₁₋₃₀ hydrocarbon group and m represents an integer of from 1 to 300;
   and/or
   an addition product obtained by the addition of 0-8 moles of an alkylene oxide having 2 to 4 carbon atoms to one equivalent of amino residues in polyamide polyamine obtained by condensation of 1.0 mole of a polyalkylene polyamine, 0.8-0.95 mole of a dibasic acid or an ester of the dibasic acid with a lower alcohol having 1 to 4 carbon atoms, and 0.05-0.18 mole of acrylic acid or methacrylic acid, or an ester of acrylic acid or methacrylic acid with a lower alcohol having 1 to 4 carbon atoms as e.g. described in EP 1 184 353;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

The present invention further provides a copolymer which is obtainable by polymerizing monomer components comprising:
(a) a compound represented by formula (A1):

Y—B—O-(A-O—)ₘR² (A1)
wherein Y represents an alkenyl group containing two or more carbon atoms, B is a bond or a CO group; A-O independently represents a C₂₋₁₈ oxyalkylene group; R² represents a hydrogen atom or a C₁₋₃₀ hydrocarbon group and m represents an integer of from 1 to 300;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

A preferred embodiment of the present invention is a copolymer which is obtainable by polymerizing monomer components comprising:
(a) a compound represented by formula (A2):

CH₂═CH—CH₂—O-(A-O—)ₘR² (A2)
wherein A-O independently represents a C₂₋₁₈ oxyalkylene group; R² represents a hydrogen atom or a C₁₋₃₀ hydrocarbon group and m represents an integer of from 1 to 300;
(b) an unsaturated dicarboxylic acid or a salt thereof or an anhydride of an unsaturated dicarboxylic acid; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

A further preferred embodiment of the present invention is a copolymer which is obtainable by polymerizing monomer components comprising:
(a) a compound represented by formula (A2):

CH₂═CH—CH₂—O-(A-O—)ₘR² (A2)
wherein A-O independently represents a C₂₋₁₈ oxyalkylene group; R² represents a hydrogen atom or a C₁₋₃₀ hydrocarbon group and m represents an integer of from 1 to 300;
(b) an unsaturated monocarboxylic acid or a salt thereof; and
(c) a compound represented by formula (C):

R¹¹R¹²C═CR¹³(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1. or 2.

A moreover preferred embodiment of the present invention is a copolymer which is obtainable by polymerizing monomer components comprising:
(a) a compound represented by formula (A4):

Z—O-(A-O—)ₘR² (A4)
wherein Z represents an acroyl group or a methacroyl group; A-O independently represents a C₂₋₁₈ oxyalkylene group; R² represents a hydrogen atom or a C₁₋₃₀ hydrocarbon group; m represents an integer of from 1 to 300;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):

R¹¹R¹²C═C¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

An especially preferred embodiment of the present invention is a copolymer which is obtainable by polymerizing monomer components comprising:
(a) a compound represented by formula (A5):

R²¹R²²C═CR²³—X—O-(A-O—)ₘR² (A5)
wherein R²¹, R²² and R²³ independently from each other represent hydrogen or methyl, X represents CH₂, CH₂CH₂, CO or a bond; A-O independently represents a C₂₋₁₈ oxyalkylene group; R² represents a hydrogen atom or a C₁₋₃₀ hydrocarbon group; m represents an integer of from 1 to 300;
(b) a compound represented by formula (B5):

R²⁴HC═CR²⁵COOM³ (B5)
wherein R²⁴ represents hydrogen or COR²⁶, R²⁵ represents hydrogen or methyl, R²⁶ represents OM⁴, and M³ and M⁴ independently from each other represent hydrogen, an alkaline metal atom, an earth alkaline metal atom, ammonium or an organic ammonium group; or wherein M³ and R²⁶ together represent a bond (i.e. B5 represents an acid anhydride); and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

The present invention further provides a copolymer which is obtainable by polymerizing monomer components comprising:
(a) a compound represented by formula (A1):

Y—B—O-(A-O—)ₘR² (A1)
wherein Y represents an alkenyl group containing two or more carbon atoms, B represents a bond or a CO group; A-O independently represents a C₂₋₁₈ oxyalkylene group; R² represents a hydrogen atom or a C₁₋₃₀ hydrocarbon group and m represents an integer of from 0 to 300;
   and/or
   an addition product obtained by the addition of 0-8 moles of an alkylene oxide having 2 to 4 carbon atoms to one equivalent of amino residues in polyamide polyamine obtained by condensation of 1.0 mole of a polyalkylene polyamine, 0.8-0.95 mole of a dibasic acid or an ester of the dibasic acid with a lower alcohol having 1 to 4 carbon atoms, and 0.05-0.18 mole of acrylic acid or methacrylic acid, or an ester of acrylic acid or methacrylic acid with a lower alcohol having 1 to 4 carbon atoms as e.g. described,in EP 1 184 353;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2;
   and, when m is 0, esterifying the resulting copolymer with a compound of formula HO-(A-O—)_{z}R^{2′}, wherein R^{2′} represents a hydrogen atom or a C₁₋₃₀ hydrocarbon group and z is an integer of from 1 to 300.

The present invention further provides a copolymer which is obtainable by polymerizing monomer components comprising:
(a) a compound represented by formula (A1):

Y—B—O-(A-O—)ₘR² (A1)
wherein Y represents an alkenyl group containing two or more carbon atoms, B represents a bond or a CO group; A-O independently represents a C₂₋₁₈ oxyalkylene group; R² represents a hydrogen atom or a C₁₋₃₀ hydrocarbon group and m represents an integer of from 0 to 300;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2;
   and, when m is 0, esterifying the resulting copolymer with a compound of formula HO-(A-O—)_{z}R^{2′}, wherein R^{2′} represents a hydrogen atom or a C₁₋₃₀ hydrocarbon group and z is an integer of from 1 to 300.

A moreover preferred embodiment of the present invention is a copolymer which is obtainable by polymerizing monomer components comprising:
(a) a compound represented by formula (A4):

Z-0-(A-O—)ₘR² (A4)
wherein Z represents an acroyl group or a methacroyl group; A-O independently represents a C₂₋₁₈ oxyalkylene group; R² represents a hydrogen atom or a C₁₋₃₀ hydrocarbon group; m represents an integer of from 0 to 300;
(b) an unsaturated monocarboxylic acid ora salt thereof, or an unsaturated dicarboxylic acid or a salt thereof or an anhydride of an unsaturated dicarboxylic acid; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2;
   and, when m is 0, esterifying the resulting copolymer with a compound of formula HO-(A-O—)_{z}R^{2′}, wherein R^{2′} represents a hydrogen atom or a C₁₋₃₀ hydrocarbon group and z is an integer of from 1 to 300.

A moreover preferred embodiment of the present invention is a copolymer which is obtainable by polymerizing monomer components comprising:
(a) a compound represented by formula (A5):

R²¹R²²C═CR²³—X—O-(A-O—)ₘR² (A5)
wherein R²¹, R²² and R²³ independently from each other represent hydrogen or methyl, X represents CH₂, CH₂CH₂, CO or a bond; A-O independently represents a C₂₋₁₈ oxyalkylene group; R² represents a hydrogen atom or a C₁₋₃₀ hydrocarbon group; m represents an integer of from 0 to 300;
(b) a compound represented by formula (B5):

R²⁴HC═CR²⁵COOM³ (B5)
wherein R²⁴ represents hydrogen or COR²⁶, R²⁵ represents hydrogen or methyl, R²⁶ represents OM⁴, and M³ and M⁴ independently from each other represent hydrogen, an alkaline metal atom, an earth alkaline metal atom, ammonium or an organic ammonium group; or wherein M³ and R²⁶ together represent a bond (i.e. B5 represents an acid anhydride); and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of _{R}¹¹, R¹² and R¹³ are hydrogen, wherein R¹⁶ is hydrogen, an alkaline metal atom, an earth alkaline metal atom, ammonium or an organic ammonium group and wherein n is 1 or 2,
   and, when m is 0, esterifying the resulting copolymer with a compound of formula HO-(A-O—)_{z}R^{2′}, wherein R^{2′} represents a hydrogen atom or a C₁₋₃₀ hydrocarbon group and z is an integer of from 1 to 300.

Therein, when m is 0, X is CO.

For the esterification reaction, preferably 1 mol of a compound of formula HO-(A-O—)_{z}R^{2′} is used per 1 to 100 mol of monomer (a) and/or 1 to 100 mol of monomer (b) which has been used in the polymerisation reaction.

Preferably, monomer component (c) is a monoester obtainable by esterification of at least one acid selected from the group consisting of maleic acid and fumaric acid, with at least one alcohol selected from the group consisting of allyl alcohol, methallyl alcohol and isoprenyl alcohol.

Especially preferably, monomer component (c) is a group of formula

H₂C═CH—CH₂—O—CO—CH═CH—COOR¹⁶; especially preferably, monomer component (c) is allyl maleate.

Preferably, the allyl maleate has a purity of at least 96% by weight, especially preferably of at least 99% by weight.

Moreover preferably, monomer component (b) is acrylic acid, methacrylic acid, fumaric acid or maleic acid or a salt thereof or maleic anhydride.

The present invention further provides a cement dispersant comprising a copolymer as described herein.

The present invention further provides a superplasticizer comprising a copolymer as described herein.

The present invention, further provides a water-soluble dispersant for mineral systems including binders, ceramics, clays, pigments, aggregates and fillers, comprising a copolymer as described herein.

The present invention further provides a dispersant for inorganic binders comprising a copolymer as described herein.

It has surprisingly been found that the presence of monomer (c) (e.g. allyl maleate) leads to an improvement of the properties of the respective superplasticizer. Further advantages which are associated with the presence of monomer (c) are a higher performance with cement, a lower dosing which is needed and a higher performance with secondary cementitious materials (SCMs), like e.g. micro silica, fly ash and ground granulated blast furnace slag, burnt oil shale, limestone and other minor cement constituents, such as e.g. calcinated shales, metakaolin, rice husk ashes and other pozzolanic materials.

It has been observed that allylmaleate is not reacting as a crosslinking agent as one might expect due to the two reactive double bonds. Instead, under radical conditions an intramolecular cyclisation is occurring which is much faster than any intermolecular polymerization. Accordingly, practically no crosslinking takes place.

According to a preferred embodiment, the present invention provides a polymer (especially a water soluble polymer) comprising the following monomer unit:

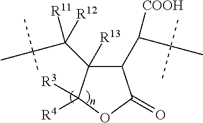

wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, and wherein n is 1 or 2.

According to an especially preferred embodiment, the present invention provides a polymer (especially a water soluble polymer) comprising the following monomer unit:

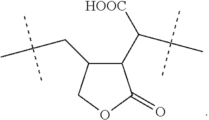

The copolymer of the present invention may also be prepared by using a compound of formula Y—B—OH or a compound of formula Y—B—O-Alkyl as monomer component (a) for the polymerisation and esterifying the resulting polymer with a compound of formula HO-(A-O—)ₘR².

According to a further embodiment, the present invention provides a copolymer which is obtainable by polymerizing monomer components comprising:
(a) a compound represented by the following formula:

Y—B—OH or Y—B—O-Alkyl
wherein Y represents an alkenyl group containing two or more carbon atoms and B represents a bond or a CO group;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2;
   and, esterifying the resulting copolymer with a compound of formula HO-(A-O—)ₘR², wherein A-O independently represents a C₂₋₁₈ oxyalkylene group; R² represents a hydrogen atom or a C₁₋₃₀ hydrocarbon group and m represents an integer of from 1 to 300.

According to a further embodiment, the present invention provides a copolymer which is obtainable by polymerizing monomer components comprising:
(a) a compound represented by the following formula:

Y—B—OH or Y—B—O-Alkyl
wherein Y represents an alkenyl group containing two or more carbon atoms and B represents a CO group; and
(c) a compound represented by formula (C):

R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2;
   and, esterifying the resulting copolymer with a compound of formula HO-(A-O—)ₘR², wherein A-O independently represents a C₂₋₁₈ oxyalkylene group; R² represents a hydrogen atom or a C₁₋₃₀ hydrocarbon group and m represents an integer of from 1 to 300.

In this embodiment, the preferred ratio of monomer (a) (the compound represented by formula Y—B—OH or Y—B—O-Alkyl) and monomer (c) is 75 to 99 mol-% monomer (a) and 1 to 25 mol-% monomer (c). Further preferably, in this embodiment, monomer (a) (the compound represented by formula Y—B—OH) is acrylic acid or methacrylic acid.

For the esterification reaction, preferably 1 mol of a compound of formula HO-(A-O—)ₘR² is used per 1.3 to 100 mol of monomer (a) which has been used in the polymerisation reaction.

It is further possible to prepare monomer (c) before the polymerisation in the polymerisation mixture (containing also monomer components (a) and (b)) in situ. In this case, 1 equivalent of the alcohol (R¹¹R¹²C═CR¹³—(CH₂)ₙ—OH, e.g. allyl alcohol) and 1 equivalent of the anhydride of the respective unsaturated dicarboxylic acid (HOOC—CH═CH—COOH, e.g. maleic anhydride) are added to the reaction mixture together with monomers (a) and (b) or before the addition of monomers (a) and (b) (e.g. 5 minutes to 5 hours before the addition of monomers (a) and (b). In this case it is preferred that monomer (b) is also said anhydride of the respective unsaturated dicarboxylic acid (HOOC—CH═Ch—COOH, e.g. maleic anhydride). In this case the reaction is preferably carried out without using a solvent.

Especially preferred is a copolymer which is obtainable by reacting 2 equivalents maleic anhydride, 1 equivalent allyl alcohol and one equivalent of a compound of formula (A2).

The copolymers of the present invention can be produced by polymerizing the monomer components using a polymerization initiator. The polymerization can e.g. be carried out in solution or as bulk polymerization.

A solution polymerization can be carried out either batchwise or continuously. All organic or inorganic solvents which are substantially inert with respect to free radical polymerization reactions may serve as solvents for the polymerization reaction, for example water, ethyl acetate, n-butyl acetate or 1-methoxy-2-propyl acetate, and alcohols, such as, for example, methanol, ethanol, isopropanol, n-butanol, 2-ethylhexanol or 1-methoxy-2-propanol, and likewise diols, such as ethylene glycol and propylene glycol. Aliphatic hydrocarbons such as cyclohexane and n-hexane, ketones, such as acetone, butanone, pentanone, hexanone and methyl ethyl ketone, alkyl esters of acetic, propionic and butyric acid, such as, for example, ethyl acetate, butyl acetate and amyl acetate, ethers, such as tetrahydrofuran, diethyl ether and ethylene glycol and polyethylene glycol monoalkyl ether and dialkyl ether, can also be used. Aromatic solvents, such as, for example, toluene, xylene or higher-boiling alkylbenzenes, may likewise be used. The use of mixtures of two or more of the above solvents is also possible. Preferably, the polymerisation is carried out in water or as bulk polymerisation (or mass polymerisation). If acid anhydrides are used as monomers, it is preferred not to use alcohols as solvents for the polymerisation.

The polymerization reaction is preferably effected in the temperature range from 0 to 180° C., particularly preferably from 10 to 100° C. (especially preferably from 50 to 90° C.), both at atmospheric pressure and at elevated or reduced pressure. The polymerization is preferably carried out under an inert gas atmosphere, e.g. under nitrogen.

High-energy, electromagnetic beams, mechanical energy or the customary chemical polymerization initiators, such as organic peroxides, e.g. benzoyl peroxide, tert-butyl hydroperoxide, methyl ethyl ketone peroxide, cumyl peroxide, dilauroyl peroxide (DLP), or azo initiators, such as, for example, azodiisobutyronitrile (AIBN), azobisamidopropyl hydrochloride (ABAH) and 2,2′-azobis(2-methylbutyronitrile) (AMBN), can be used for initiating the polymerization. Inorganic peroxy compounds, such as, for example, (NH₄)₂S₂O₈, K₂S₂O₈ or H₂O₂, optionally in combination with reducing agents (e.g. sodium hydrogen sulfite, ascorbic acid, iron(II) sulfate) or redox systems which contain an aliphatic or aromatic sulfonic acid (e.g. benzenesulfonic acid, toluenesulfonic acid) as reducing component are likewise suitable. A preferred radical initiator for bulk polymerization is benzoylperoxide. A preferred radical initiator for aqueous polymerization is sodium- or ammonium persulphate.

Further additives may be added to the polymerisation reaction such as e.g. agents for regulating the molecular weight and chelating agents such as EDTA. The customary compounds may be used as chain-transfer agents for regulating the molecular weight. As the chain transfer agents, known hydrophobic chain transfer agents or hydrophilic chain transfer agents may be used alone, or two or more of these may be used in combination. Suitable hydrophobic chain transfer agents are thiol compounds having a hydrocarbon group containing not less than 3 carbon atoms or compounds whose solubility in water at 25° C. is not more than 10%. For example, suitable thiol chain transfer agents such as butanethiol, octanethiol, decanethiol, dodecanethiol, hexadecanethiol, octadecanethiol, cyclohexyl mercaptan, thiophenol, octyl thioglycolate, octyl 2-mercaptopropionate, octyl 3-mercaptopropised one or two or more species may be used in combinatioonate, 2-ethylhexyl mercaptopropionate, 2-mercaptoethyl octanoate, 1,8-dimercapto-3,6-dioxaoctane, decanetrithiol, and dodecyl mercaptan; halides such as carbon tetrachloride, carbon tetrabromide, methylene chloride, bromoform, and bromotrichloroethane; unsaturated hydrocarbon compounds such as α-methylstyrene dimer, α-terpinene, γ-terpinene, dipentene, and terpinolene; and the like. These may be used alone, or two or more of these may be used in combination. Also suitable as the above hydrophilic chain transfer agents are thiol chain transfer agents such as mercaptoethanol, thioglycerol, thioglycolic acid, mercaptopropionic acid, 2-mercaptopropionic acid, 3-mercaptopropionic acid, thiomalic acid, and 2-mercaptoethanesulfonic acid; primary alcohols such as 2-aminopropane-1-ol; secondary alcohols such as isopropanol; phosphorous acid, hypophosphorous acid and salts thereof (e.g. sodium hypophosphite, potassium hypophosphite), sulfurous acid, hydrosulfurous acid, dithionous acid, metabisulfurous acid, and salts thereof (e.g. sodium sulfite, sodium hydrogen sulfite, sodium pyrosulfite, sodium dithionite, sodium metabisulfite, potassium sulfite, potassium hydrogen sulfite, potassium dithionite, potassium metabisulfite). These may be used alone or in combination of two or more species. As for the method of adding the above chain transfer agent to the reaction vessel, a continuous charging method such as dripping and divided charging can be applied. The chain transfer agent may be introduced singly into the reaction vessel, or it may be admixed in advance with the monomer or solvent. Further suitable known chain-transfer agents are for example, (Meth)allyl sulfonic acid, 3-Allyloxy-2-hydroxyl-propanesulfonic acid (AHPS).

Preferably, the ratio of monomers (a), (b) and (c) is 1 to 99 mol-% monomer (a), 0.5 to 98 mol-% monomer (b) and 0.5 to 98 mol-% monomer (c). Further preferably, the ratio of monomers (a), (b) and (c) is 2 to 50 mol-% monomer (a), 25 to 50 mol-% monomer (b) and 1 to 50 mol-% monomer (c).

An especially preferred ratio (especially for APEG-type PCEs) of monomers (a), (b) and (c) is 30 to 35 mol-% monomer (a), 30 to 35 mol-% monomer (b) and 30 to 35 mol-% monomer (c). Most preferably, monomers (a), (b) and (c) are used equimolar (especially for APEG-type PCEs).

A further especially preferred ratio (especially for MPEG-type PCEs) of monomers (a), (b) and (c) is 15 to 25 mol-% monomer (a), 55 to 65 mol-% monomer (b) and 15 to 25 mol-% monomer (c). Most preferably, monomers (a), (b) and (c) are used in a molar ratio of 1:3:1 (especially for MPEG-type PCEs).

Other monomers may be used in the synthesis of the copolymer of the present invention besides monomers (a), (b) and (c). Examples for such further monomers are 2-Acrylamido-2-methylpropane sulfonic acid (AMPS), Vinylphosphonic acid, styrene, diisobutylmaleate, polyamidoamines as e.g. described in EP 1 184 353 (WO 00/39045) attached to unsaturated compounds such as e.g. (meth)acrylic acid, (meth)acrylic acid ester and monomers which posess two .rective double bonds (e.g. diesters) as e.g. described in U.S. Pat. No. 5,476,885.

The method of adding the monomer components or polymerization initiator etc. to the reaction vessel in the above-mentioned polymerization reaction is not particularly limited. Suitable examples of the method include a method comprising charging the reaction vessel with all the monomer components and then adding the polymerization initiator thereto to conduct copolymerization; a method comprising charging the reaction vessel with some of the monomer components and then adding the polymerization initiator and residual monomer components thereto to conduct polymerization; and a method comprising charging the reaction vessel with the polymerization solvent and then adding the whole amount of the monomer components and polymerization initiator thereto. Among such methods, the method comprising carrying out the polymerization by adding dropwise the polymerization initiator and the monomer components successively to the reaction vessel is preferred since the molecular weight distribution of the product copolymer can be made narrow (sharp), and the cement dispersibility for increasing the fluidity of cement compositions and the like can be improved thereby. Furthermore, the copolymerization reaction is preferably carried out with maintaining the amount of solvent in the reaction vessel during the polymerization to not more than 80% since the preservation stability of the obtained polymer is more improved by the improvement of the copolymerizability of the monomer components. More preferably, it is not more than 70%, still more preferably not more than 60%. Furthermore, the copolymerization reaction is preferably carried out with maintaining the density of solvent in the reaction vessel during the polymerization to not more than 50%. More preferably, it is not more than 40%, still more preferably not more than 30%.

If the polymerization is carried out as bulk polymerisation without solvent, the reaction mixture is preferably treated with water to stop the polymerization. This leads to an aqueous solution of the copolymer. Additionally, radical quenchers may be added to stop the reaction. Optionally, the solution may be neutralized with a base (e.g. sodium hydroxide). If the polymerization is carried out in an aqueous solution, the reaction mixture is preferably neutralized with an alkaline substance. Preferably used as the alkaline substance are inorganic salts such as monovalent and divalent metal hydroxides, oxides, chlorides and carbonates; ammonia; organic amines, or the like (e.g. sodium hydroxide).

The copolymer of the present invention is preferably administered as 5-60% strength aqueous solution and particularly preferably as 20 to 45% strength aqueous solution, as dispersant, superplasticizer, sequestering agent or plasticizer, for the intended use.

A further administration form of the copolymer of the present invention is powder or granule, which are prepared by drying the copolymer solution obtainable after the polymerization, e.g. by spray drying (optionally followed by a granulation step) or by drum drying.

The copolymer of the present invention preferably has a molecular weight of from 1000 g/mol to 1000000 g/mol; especially of from 5000 g/mol to 300000 g/mol; more preferably of from 10000 g/mol to 150000 g/mol. The weight average molecular weight can e. g. be determined by gel permeation chromatography according to the following procedure: A 10 mg/mL solution of the polymer was prepared for size exclusion chromatography (SEC) analysis. Measurement was performed on a Waters 2695 Separation Module equipped with three Ultrahydrogel™ columns (120, 250, 500) and an Ultrahydrogel™ guard column from Waters, Eschborn Germany, and a subsequent 3 angle static light scattering detector (“mini Dawn” from Wyatt Technology Corp., Santa Barbara, Calif. USA). The polymer concentration was monitored with a differential refractive index detector (RI 2414, Waters, Eschborn/Germany). Aqueous 0.1 N NaNO₃ solution adjusted to pH 12 with NaOH was used as an eluent at a flow rate of 1.0 mL/min. From the SEC measurements, the polydispersity index (PDI), the molar masses (M_{w} and Mₙ) as well as the hydrodynamic radius (Rₕ) were obtained. The value of dn/dc used to calculate. M_{w} and Mₙ was 0.135 mL/g (value for polyethylene glycol).

The copolymer of the present invention is suitable as flow improver, plasticizer and superplasticizer for hydraulic, latent hydraulic and non-hydraulic binder systems, such as, for example, Portland cement (CEM I), GEM II—CEM V, hydraulic lime, lime, concrete, mortar, screed mortar, geopolymer binder, CaSO₄*n H₂O binder suspensions, calcium aluminate cements, their formulations, and mixtures thereof, for ceramic materials comprising clays, kaolins, feldspars and quartz minerals.

The copolymers of the present invention may be favorably used for various applications such as adhesives, sealants, flexibility-imparting components for various polymers, dispersants and grinding agents for cement, and builders for cleaning agents. In particular, they are preferably used for a dispersant for inorganic binders such as cement because of their extremely high dispersibility. Accordingly, the use of the copolymers of the present invention as a copolymer for a dispersant for cement is one of the preferable embodiments of the present invention.

The dispersant of the present invention may be also used in combination with other additives. Examples of the other additives include the following dispersants and additives (and materials), and each of these may be used alone or two or more of these may be used in combination. Particularly preferable among these is a combination of an oxyalkylene antifoaming agent and an AE agent:
Dispersants based on polycondensation such as BNS, PMS, AFS, SFP dispersants having a sulfonic acid group in the molecule, or a polycarbonic acid dispersant having a polyoxyalkylene chain and a carboxylic group in the molecule; and
Additives (materials) for cement such as water-soluble macromolecular substances, polymer emulsions, retarders, high-early-strength agents or accelerators, mineral oil antifoaming agents, fat or oil antifoaming agents, fatty acid antifoaming agents, fatty acid ester antifoaming agents, oxyalkylene antifoaming agents, alcohol antifoaming agents, amido antifoaming agents, phosphate ester antifoaming agents, metal soap antifoaming agents, silicone antifoaming agents, AE (air-entraining) agents, surfactants, water-proof agents, corrosion inhibitors, crack inhibitors, expansive additives, cement wetting agents, thickening. agents, segregation reducing agents, flocculants, drying shrinkage reducing agents, agents to increase strength, self-leveling agents, colorants, antifungal agents, blast-furnace slag, fly ash, cinder ash, clinker ash, husk ash, silica fume, micro and nano silica powder, and gypsum.

The dispersant of the present invention may be used in an aqueous solution form. After the reaction, the dispersant is neutralized with a hydroxide of a mono or divalent metal. such as sodium, potassium, calcium and magnesium or ammonium to be a mono or polyvalent salt; or carried on inorganic powders such as talc, kaolin, silica fine particles and then optionally dried; or dried or solidified to be a thin film on a support using a drum drier, a disk drier, or belt drier, and then pulverized; or dried or solidified using a spray drier, thereby being pulverized. Further, the pulverized dispersant for cement of the present invention is previously mixed with a cement composition free from water, such as cement powders and dry mortar, and then used as a premix product applied for plasters, floor finishing, floor screeds, SLUS, injection grout, oil well cements and the like, or added when the cement composition is mixed. For ease of handling, an aqueous solution form is preferable.

The dispersant of the present invention can be used in various hydraulic, latent hydraulic and non-hydraulic materials, that is, cement compositions such as cement and plaster, and other hydraulic materials. Specific examples of a hydraulic composition which contains such a hydraulic material, water, and the dispersant for cement of the present invention, and if necessary, a fine aggregate (e.g., sand) or a coarse aggregate (e.g., gravel) include cement paste, mortar, concrete, and plaster. Among these hydraulic compositions, the cement composition including cement as a hydraulic material is most common. Such a cement composition includes the dispersant for cement of the present invention, cement, and water.

The unit water content, cement content, and water/cement ratio (weight ratio) per 1 m³ of the cement composition is preferably as follows: unit water content of 100 to 185 kg/m³; cement content of 100 to 800 kg/m³; and water/cement ratio (weight ratio) of 0.1 to 1.0. They are more preferably as follows: unit water content of 120 to 175 kg/m³; cement content of 250 to 800 kg/m³; and water/cement ratio (weight ratio) of 0.2 to 0.65. As mentioned here, the dispersant for cement containing the copolymer of the present invention may be used at a wide amount range from a small amount to a large amount. It may be used at a high water reducing ratio, that is, a region with a water/cement ratio (weight ratio) as low as 0.15 to 0.5 (preferably 0.15 to 0.4). Further, it may be useful for high strength concrete with a large unit cement content and low water/cement ratio and low cement concrete with a unit cement content of 300 kg/m³ or less.

The dispersant for cement containing the copolymer of the present invention shows high fluidity, fluidity retaining ability (slump retention), and workability at good balance even in the high water reducing ratio region, and has excellent workability. Thus, it is capable of being effectively used for concrete such as ready mixed concrete, precast concrete, concrete for centrifugal molding, autoclaved concrete, concrete for compaction by vibration, steam curing concrete, and sprayed concrete. In addition, it is also useful for mortar and concrete which are required to have high fluidity such as middle performance concrete (concrete with a slump value of 22 to 25 cm), high performance concrete (concrete with a slump value of 25 cm or higher and with a slump flow value of 50 to 70 cm), self-compacting concrete, and self-leveling materials.

In the above-mentioned cement composition, the ratio of the amount of the copolymer of the present invention to be blended is preferably set to 0.01 to 10% by mass in solids content for 100% by mass in total of the cement weight. If the amount thereof is less than 0.01% by mass, the composition may insufficiently show its performance, while if the amount is more than 10% by mass, the performance thereof may not be improved substantially and may be disadvantageous from the economical view. The amount thereof is more preferably 0.01 to 8% by mass, and further preferably 0.01 to 3% by mass.

The term unsaturated monocarboxylic acid relates to a compound having a double bond and one carboxylic group capable of forming a carboxylate anion. Preferably, the term monocarboxylic group relates to a compound having 3 to 6 (especially 3 or 4) carbon atoms. Examples are acrylic acid and methacrylic acid.

The term unsaturated dicarboxylic acid relates to a compound having a double bond and two carboxylic groups capable of forming a carboxylate anion. Preferably, the term monocarboxylic group relates to a compound having 4 to 6 (especially 4 or 5) carbon atoms. Examples are maleic acid, itaconic acid, fumaric acid, mesaconic acid and citraconic acid. Preferred is maleic acid. The preferred anhydride of an unsaturated dicarboxylic acid is maleic anhydride

Preferred salts of the unsaturated monocarboxylic acid and the unsaturated dicarboxylic acid are alkaline and earth alkaline salts such as e.g. lithium, sodium, potassium, calcium and magnesium and ammonium.

The term alkenyl refers to an at least partially unsaturated, straight-chain or branched hydrocarbon group having from 2 to 20 carbon atoms, preferably from 2 to 12 carbon atoms, especially from 2 to 6 carbon atoms, for example the ethenyl, allyl, isoprenyl or hex-2-enyl group. Preferably the alkenyl group has one double bond. The allyl group is preferred.

The term alkyl refers to a saturated, straight-chain or branched hydrocarbon group having e.g. from 1 to 30 (such as from 1 to 20) carbon atoms, preferably from 1 to 12 carbon atoms, especially from 1 to 6 carbon atoms, for example the methyl, ethyl, propyl, isopropyl, isobutyl, tert-butyl, n-hexyl, 2,2-dimethylbutyl or n-octyl group.

The term C₁.₃₀ hydrocarbon group relates to a hydrocarbon group having from 1 to 30 carbon atom.

As typical examples of the hydrocarbon group, linear and branched alkyl groups having from 1 to 30 carbon atoms may be cited, such as methyl, ethyl, n-propyl, isopropyl, n-butyl, isobutyl, sec-butyl, tert-butyl, pentyl, isoperityl, neopentyl, hexyl, heptyl, octyl, nonyl, decyl, undecyl, dodecyl, isooctyl, 2,3,5-trimethylhexyl, 4-ethyl-5-methyloctyl, 2-ethylhexyl, tetradecyl, octadecyl, and icosyl; cyclic alkyl groups such as cyclopropyl, cyclobutyl, cyclopentyl, cyclohexyl, cycloheptyl, and cyclooctyl; aryl groups such as phenyl, benzyl, phenetyl, o-, m-, or p-tolyl, 2,3- or 2,4-xylyl, mesityl, naphthyl, anthryl, phenanthryl, biphenylyl, benzhydryl, trityl, and pyrenyl, and alkyl group-containing aryl groups ((alkyl)aryl groups); hydrogenated aryl groups resulting from hydrogenating at least part of the aryl groups and alkyl group-containing hydrogenatedarylgroups ((alkyl)hydrogenatedarylgroups); and (alkyl)aralkyl groups such as benzyl, methylbenzyl, phenetyl, naphthylmethyl, and naphthylethyl. The methyl group is especially preferred.

Typical examples of alkaline metal atoms comprise lithium, sodium and potassium, preferably sodium and potassium.

Typical examples of earth alkaline metal atoms comprise magnesium, calcium, strontium and barium, preferably calcium and magnesium.

Examples of the organic ammonium group, comprise groups originating from primary amines such as methyl amine, ethyl amine, propyl amine, n-butyl amine, sec-butyl amine, tert-butyl amine, cyclohexyl amine, benzyl amine, and phenyl amine; groups originating from secondary amines such as dimethyl amine, diethyl amine, dipropyl amine, dibutyl amine, diisobutyl amine, di-sec-butyl amine, di-tert-butyl amine, dicyclohexyl amine, dibenzyl amine, and diphenyl amine; groups originating from tertiary amines such as trimethyl amine, triethyl amine, tripropyl amine, tributyl amine, tricyclohexyl amine, tribenzyl amine, diisopropylethyl amine and triphenyl amine; and groups originating from alkanol amines as ethanol amine, diethanol amine, and triethanol amine (in their protonated ammonium form). Among other organic amine groups cited above, alkanol amine groups such as the ethanol amine group, diethanol amine group, and the triethanol amine group and triethyl amine groups are favorable.

The term C₂₋₁₈ oxyalkylene group relates to an oxyalkylene group having 2 to 18 carbon atoms, preferably an oxyalkylene group having 2 to 8 carbon atoms and especially preferably an oxyalkylene group having 2 to 4 carbon atoms. As preferred examples of this oxyalkylene group, ethylene oxide, propylene oxide and butylene oxide may be cited. Ethylene oxide and propylene oxide prove still more favorable. Ethylene oxide is the most prefered oxyalkylene group. These oxyalkylenes may be used either singly or in the form of a mixture of two or more members. Therefore all groups A-O in (A-O)ₘ may be the same or may be different.

Preferably, Y is a group of formula R²¹R²²C═CR²³—CH₂—, wherein R²¹, R²² and R²³ independently are a hydrogen atom or a methyl group.

Especially preferably, Y is an allyl group (H₂C═CH—CH₂—).

Further preferably, Y is a group of formula R²⁷R²⁸C═CR²⁹—, wherein R²⁷, R²⁸ and R²⁹ independently are a hydrogen atom or a methyl group.

Further especially preferably, Y is group of formula H₂C═CR²⁹—, wherein R²⁹ is a hydrogen atom or a methyl group.

Further preferably, A-O is a group of formula CH₂—CH₂—O.

Further preferably, m is an integer of from 1 to 150, especially of from 5 to 50 and further preferably of from 20 to 50.

Moreover preferably, m is 0.

Further preferably, z is an integer of from 1 to 150, especially of from 5 to 50 and further preferably of from 20 to 50.

Further preferably, R² is a hydrogen atom or a C₁-C₈ hydrocarbon group (such as a C₁-C₈ alkyl group). It is more specifically a hydrogen atom or a C₁-C₆ hydrocarbon group (such as a C₁-C₆ alkyl group), further preferably a hydrogen atom or a C₁-C₃ hydrocarbon group (such as a C₁-C₃ alkyl group), and particularly preferably a hydrogen atom or a methyl group.

Further preferably, R^{2′} is a hydrogen atom or a C₁-C₈ hydrocarbon group (such as a C₁-C₈ alkyl group). It is more specifically a hydrogen atom or a C₁-C₆ hydrocarbon group (such as a C₁-C₆ alkyl group), further preferably a hydrogen atom or a C₁-C₃ hydrocarbon group (such as a C₁-C₃ alkyl group), and particularly preferably a hydrogen atom or a methyl group.

Further preferably, R³ and R⁴ independently from each other are hydrogen or methyl. Especially preferrably, R³ and R⁴ are both hydrogen atoms.

Further preferably, n is 1.

Further preferably, R¹¹, R¹² and R¹³ are all hydrogen atoms.

### EXAMPLES

1. APEG Type PCE

APEG PCE can be polymerized in bulk or in aqueous solution. A common radical initiator for bulk polymerization is benzoylperoxide or Azoisobutyronitrile (AIBN), for aqueous polymerization sodium-, potassium- or ammonium persulphate.

As monomers, maleic anhydride and an allylether are used. The molar ratio usually is 1:1, as strongly alternating polymers can be expected originating from the electronic structure of the monomers. Excess allylether will stay unreacted in the reaction mixture.

An allylmaleate content of up to 2 eq can be used to optimize PCE performance. Best polymers were found with a molar ratio of maleic anhydride:allylether : allylmaleate 1:1:1.

Polymerization Methods

Bulk: Monomers are fed into reaction vessel and heated to 100° C. Radical initiator added over 90 minutes, total stirring time 90 minutes. After completion, dissolution in water to achieve ˜50% solid content and neutralized to pH=6-8 with NaOH solution.

Solution: Monomers are dissolved in water to achieve ˜20-50% solid content and heated to 90° C. Initiator added over ˜4 hours, total stirring time ˜8 hours. After completion neutralization to pH=6-8 with NaOH solution.

### Example 1.1

6.25 g maleic anhydride and 3.72 g allyl alcohol are fed into a three neck flask and heated to 60° C. for 1 hour. This will produce allylmaleate. It is critical to avoid any molar excess of allyl alcohol. During the reaction, the maleic anhydride will melt and form a homogeneous reaction product with the allyl alcohol which is allyl maleate with a purity of about 96%. The synthesis method described here inevitably produces a small amount of diallyl maleate (˜2%) which can act as a crosslinking agent during subsequent PCE synthesis which makes the polymer ineffective as cement dispersant. Therefore, higher concentrations of diallyl maleate must be avoided, and the best way is to react maleic anhydride with a slight substoichiometric amount of allyl alcohol. To further purify the allyl maleate, it was distilled under vacuum (3 hPa) to yield a colorless, nearly odourless liquid. The allyl maleate should be stored in a cool, dark place and should be consumed rapidly as it was found to undergo self polymerization.

Afterwards, another 6.25 g maleic anhydride and 100 g allylether (34 EO units) are added and the mixture is heated to 90° C. Additionally, the reaction vessel is purged with inert gas, preferably nitrogen gas. 2.00 g of benzoylperoxide are added as powder continiously over a time of 90 minutes. Then the mixture is heated to 100° C. and is stirred for another 90 minutes. The viscosity of the mixture will gradually increase, but is easily to stir for the whole reaction period. At the end, approximately 120 g of deionised water are added into the still hot reaction mixture to yield a polycarboxylate solution of ˜50% solids content. The solution can be neutralized with 30 wt-% aqueous NaOH which will produce the Na salt of the PCE. (CMA-1)

### Example 1.2

The synthesis was carried out as described in example 1.1, containing the following monomer ratios: 10.0 g maleic anhydride, 30.0 g allylether (34 EO units), 3.0 g allyl alcohol, 0.7 g benzoylperoxide.

### Example 1.3

The synthesis was carried out as described in example 1.1, containing the following monomer ratios: 17.0 g maleic anhydride, 30.0 g allylether (10 EO units), 3.4 g ally, alcohol, 1.25 g benzoylperoxide.

### Example 1.4

The synthesis was carried out as described in example 1.1, containing the following monomer ratios: 9.4 g maleic anhydride, 50.0 g allylether (34 EO units), 4.0 g allyl alcohol, 1.2 g benzoylperoxide.

### Example 1.5

The synthesis was carried out as described in example 1.1, containing the following monomer ratios: 4.7 g maleic anhydride, 50.0 g allylether (70 EO units), 2.0 g allyl alcohol, 0.6 g benzoylperoxide. (CMA-10)

### Example 1.6

The synthesis was carried out as described in example 1.1, containing the following monomer ratios: 4.1 g maleic anhydride, 82.0 g allylether (90 EO units), 1.2 g allyl alcohol, 0.8 g benzoylperoxide. (CMA-21)

### Example 1.7

The synthesis was carried out as described in example 1.1 except methallylalcohol was used instead of allylalcohol, containing the following monomer ratios: 6.5 g maleic anhydride, 50.0 g allylether (34 EO units), 2.9 g methallyl alcohol, 1.0 g benzoylperoxide. (CMA-22)

Mini Slump Test

For the determination of the paste flow, a ‘mini slump’ test was utilized and carried out as follows: First, a constant water to cement (w/c) ratio of 0.3 was chosen. At this w/c ratio, the dosages of polymers required to reach a spread of 26±0.5 cm were determined. Generally, the polymer was added to the required amount of mixing water placed in a porcelain casserole. When aqueous polymer solutions were used, then the amount of water contained in the polymer solution was subtracted from the amount of mixing water. Next, 350 g of cement were added to the mixing water and agitated by hand for 1 minute, then rested for 1 minute without stirring. This was followed by intensive stirring for another 2 minutes. Thereafter, the cement paste was immediately poured into a Vicat cone (height 40 mm, top diameter 70 mm, bottom diameter 80 mm) placed on a glass plate and the cone was vertically removed. The resulting spread of the paste was measured twice, the second measurement being in a 90° angle to the first and averaged to give the spread value.

In case of performance tests with anhydrite, the potassium sulphate used as accelerator is dry mixed with the anhydrite prior to the addition to the mixing water. The dosage of potassium sulphate was 1% by weight of binder (bwob). For the experiment, 350 g of anhydrite were dry mixed with 3.50 g of potassium sulphate. The following steps were identical to the mini slump test with cements using constant water to binder (w/b) ratio of 0.3 and adjusting the PCE dosage to achieve a spread of 26+˜0.5 cm.

Performance examples w/c=0.3, cement paste; MA-1=reference PCE without allylmaleate, CMA-1 to CMA-22 as described in examples.

| | | Dosage % | Slump flow |
|---|---|---|---|
| PCE | Cement | bwoc | [cm] |
| MA-1 | Milke CEM I 42,5 R | 0.2% | 26.2 |
| MA-1 | Rohrdorf CEM I 32,5 R | 0.2% | No flow |
| MA-1 | Rohrdorf CEM I 32,5 R | 0.6% | 19.0 |
| MA-1 | Holcim CEM I 52,5 R | 0.3% | 25.5 |
| CMA-1 | Milke CEM I 42,5 R | 0.12% | 26.5 |
| CMA-1 | Rohrdorf CEM I 32,5 R | 0.24% | 25.8 |
| CMA-1 | Holcim CEM I 52,5 R | 0.13% | 26 |
| CMA-10 | Milke CEM I 42,5 R | 0.15% | 25.5 |
| CMA-10 | Rohrdorf CEM I 32,5 R | 0.21% | 25.8 |
| CMA-10 | Holcim CEM I 52,5 R | 0.15% | 26.4 |
| CMA-21 | Rohrdorf CEM I 32,5 R | 0.5% | 25.8 |
| CMA-22 | Milke CEM I 42,5 R | 0.15% | 25.9 |
| CMA-22 | Rohrdorf CEM I 32,5 R | 0.31% | 25.8 |

Compatibility with microsilica: Cement slurry containing 16.32% bwoc Elkem 971-U microsilica, Holcim CEM I 52.5 R; w/c=0.3

| | | Dosage % | Slump flow |
|---|---|---|---|
| PCE | Cement | bwoc | [cm] |
| MA-1 | Holcim + MS | 1.1% | 26.2 |
| CMA-1 | Holcim + MS | 0.7% | 26.0 |
| CMA-10 | Holcim + MS | 0.65% | 26.2 |

Performance with anhydrite: Anhydrite slurry containing 1% bwob potassium sulphate as accelerator; w/b=0.3

| PCE | Dosage % bwob | Slump flow [cm] |
|---|---|---|
| MA-1 | 0.65 | 26.2 |
| CMA-1 | 0.45 | 26.6 |

Performance with calcium aluminate cement (CAC): Cement paste; w/c=0.3

| | | Dosage % | Slump flow |
|---|---|---|---|
| PCE | Cement | bwoc | [cm] |
| MA-1 | Ternal White (70% Al₂O₃) | 0.085 | 26.0 |
| CMA-1 | Ternal White (70% Al₂O₃) | 0.070 | 26.5 |
| MA-1 | Ternal RG-S (40% Al₂O₃) | 0.055 | 26.5 |
| CMA-1 | Ternal RG-S (40% Al₂O₃) | 0.040 | 26.4 |

2. MPEG PCE

MPEG PCEs are commonly polymerized in aqueous solution using sodium or ammonium persulphate as radical initiator. Monomers are methacrylic acid and a MPEG methacrylate. Since the reactivity of these monomers is very similar, the molar ratios are frequently changed to adapt the PCE to ones needs. High acid contents cause high initial flow but bad slump retention. Low acid contents show the opposite behaviour.

Due to the high reactivity of these monomers, a chain transfer agent, such as thiols or sulphonic acids is added to reduce molecular weight of the polymers. Allylmaleate or derivates can be added up to 20 wt-% of the polymer. As allylmaleate is reacting slow compared to the other monomers, the amount of chain transfer agent needs to be reduced when using high allylmealeate contents.

Polymerization Methods

Monomers are dissolved in water to achieve ˜20-50% solid content. A small amount of water is added to the reaction vessel and heated to 90° C. Initiator and monomer solution are added simultaneously over ˜4 hours, total stirring time ˜8 hours. After completion neutralization to pH=6-8 with NaOH solution.

### Example 2.1

83.4 g methacrylic MPEG ester (25 EO units), 16.6 g methacrylic acid, 0.84 g mercaptopropionic acid, 10.0 g allylmaleate and 25 g H₂O are mixed in a beaker. In another beaker, 1.15 g ammonium persulfate are dissolved in 100 g H₂O. In a five neck flask with stirrer, 85 g H₂O are added and heated to 80° C. while continuously purging with inert gas, preferably nitrogen gas. The solution containing the monomers is added to the reaction vessel over 4 hours. The solution containing the radical initiator is added simultaneously over 5 hours. After all solution is added, the reaction mixture is stirred for another hour. The reaction mixture will turn turbid during this process.

At the end, the reaction mixture is neutralized to pH ˜6.8 with 30 wt. % NaOH solution to yield the PCE superplasticizer with a solid content of ˜33%.

### Example 2.2

The synthesis was carried out as described in example 2.1, containing the following monomer ratios: 83.4 g MPEG ester (25 EO units), 16.6 g methacrylic acid, 1.6 g mercaptopropionic acid, 10.0 g allylmealeate and 25 g H₂O for solution 1. For solution 2, 1.3 g amonium persulphate were dissolved in 100 g H₂O. The reaction vessel was charged with 50.0 g H₂O.

### Example 2.3

The synthesis was carried out as described in example 2.1, containing the following monomer ratios: 160 g MPEG ester (45 EO units), 16.6 g methacrylic acid, 1.6 g mercaptopropionic acid, 20.0 g allylmealeate and 50 g H₂O for solution 1. For solution 2, 1.3 g amonium persulphate were dissolved in 100 g H₂O. The reaction vessel was equipped with 85.0 g H₂O. (MPEG-01-AMA)

### Example 2.4

The synthesis was carried out as described in example 2.1, containing the following monomer ratios: 160 g MPEG ester (45 EO units), 33.0 g methacrylic acid, 1.6 g mercaptopropionic acid, 20.0 g allylmaleate and 50 g H₂O for solution 1. For solution 2, 1.3 g amonium persulphate were dissolved in 100 g H₂O. The reaction vessel was equipped with 85.0 g H₂O.

Performance examples w/c=0.3, cement slurry; MPEG-01=reference PCE without allylmaleate, MPEG-01-AMA=PCE with 10 m-% allylmaleate, n_{EO}=25 in both cases. Methacrylic acid: MPEG ester=3:1. Identical polymerization conditions.

| | | Dosage % | Slump flow |
|---|---|---|---|
| PCE | Cement | bwoc | [cm] |
| MPEG-01 | Rohrdorf CEM I 32,5 R | 0.6% | 22.3 |
| MPEG-01 | Rohrdorf CEM I 32,5 R | 1.2% | 23.3 |
| MPEG-01-AMA | Rohrdorf CEM I 32,5 R | 0.4% | 25.7 |

Compatibility with microsilica: Cement slurry containing 16.32% bwoc Elkem 971-U microsilica, Holcim CEM I 52,5 R; w/c=0.3

| | | Dosage % | Slump flow |
|---|---|---|---|
| PCE | Cement | bwoc | [cm] |
| MPEG-01 | Holcim + MS | 1.0% | 25.5 |
| MPEG-01-AMA | Holcim + MS | 1.0% | 29.5 |
| MPEG-01-AMA | Holcim + MS | 0.8% | 28.3 |
| MPEG-01-AMA | Holcim + MS | 0.6% | 24.5 |

Performance with anhydrite: Anhydrite slurry containing 1% bwob potassium sulphate as accelerator; w/b =0.3

| PCE | Dosage % bwob | Slump flow [cm] |
|---|---|---|
| MPEG-01 | 0.60 | 25.5 |
| MPEG-01-AMA | 0.35 | 26.5 |

3. IPEG PCE

IPEG PCE can be polymerized under identical conditions as MPEG PCE.

### Example 3.1

80 g isoprenolether (25 EO units), 8.0 g acrylic acid, 1.0 g mercaptopropionic acid, 10.0 g allylmaleate and 25 g H₂O are mixed in a beaker. In another beaker, 1.0 g ammonium persulfate are dissolved in 100 g H₂O. In a five neck flask with stirrer, 50 g H₂O are added and heated to 80° C. while continuously flushing with inert gas, preferably nitrogen gas. The solution containing the monomers is added to the reaction vessel over ˜4 hours. The solution containing the radical initiator is added simultaneously over ˜5 hours. After all solution is added, the reaction mixture is stirred for another hour.

At the end, the reaction mixture is neutralized to pH ˜6-8 with 30 wt. % NaOH solution to yield the PCE superplasticizer with a solid content of ˜33%.

4. PCE Preparation by esterification of polymethacrylic Acid

Polymethacrylic acid can be prepared by aqueous radical polymerization of methacrylic acid in the presence of a chain transfer agent such as mercaptopropionic acid or other thiols. In a second step, the polymethacrylic acid is esterified with methoxypolyethyleneglycol to produce the final PCE superplasticizer.

### Example 4.1

In the beginning, two solutions are prepared: Solution 1 contains 100 g deionized water, 100 g methacrylic acid, 5.0 g mercaptopropionic acid and 10.0 g allylmaleate. Solution 2 contains 1.0 g sodiumpersulfate and 80 g deionized water. In a three neck flask with stirrer, 150 g of deionized water were heated to 90° C. While stirring, solution 1 and solution 2 are now added continuously over 3 hours. After all solutions are added, the reaction mixture is stirred for one more hour at 90° C. The viscosity of the colorless reaction mixture will increase significantly during the monomer and initiator addition.

A solution of polymethacrylic acid with a solids content of ˜30% is obtained. The molecular weight was found to be M_{w}=12.000 Da determined by gel permeation chromatography.

The final PCE was prepared by esterification of this polymethacrylic acid with methoxypolyethyleneglycol.

This is done by adding 33 g of 30 wt.-% solution of polymethacrylic acid to a round bottom flask. 35 g of methoxypolyethyleneglycol (M_{w}=1000 Da, PEG-M-1000) and 0.45 g of lithium hydroxide which acts as esterification catalyst were added to this mixture. The mixture is heated to reflux and stirred until a homogenous solution was obtained. A vacuum is created in the flask and the water is removed by distillation. Upon complete removal of the water, the reaction mixture will solidify to a colorless mass. A high vacuum (˜0.01 mbar) is now applied and the mixture is heated to 175° C. The mixture will slowly begin to melt while releasing large quantities of gas. The reaction is complete when a clear melt is obtained and the gas release comes to an end.

After cooling, the polymer is dissolved in deionized water to obtain a ˜50 wt. % PCE solution. The solution may be neutralized to pH=7 with 30 wt. % NaOH solution to produce the sodium salt of the PCE. The molecular weight of the PCE polymer is M_{w}˜55.000 Da found by gel permeation chromatography.

Performance example: w/c=0.3; G-MPEG-01=reference PCE without allylmaleate, G-MPEG-01-AMA=PCE with 10 wt. % allylmaleate, n_{EO}=25 in both cases. Polymethacrylic acid:Methoxypolyethyleneglycol=1:3.5 by weight in both cases. The PCEs were prepared by identical esterification procedure of polymethacrylic acid or polymethacrylic acid containing allylmaleate.

| | | Dosage % | Slump flow |
|---|---|---|---|
| PCE | Cement | bwoc | [cm] |
| G-MPEG-01 | Rohrdorf CEM I 32,5 R | 0.5% | 23.4 |
| G-MPEG-01 | Rohrdorf CEM I 32,5 R | 0.8% | 25.8 |
| G-MPEG-01-AMA | Rohrdorf CEM I 32,5 R | 0.35% | 25.9 |

1. A copolymer obtainable by polymerizing monomer components comprising:
(a) a compound represented by formula (A1):
Y—B—O-(A-O—)ₘR² (A1)
wherein Y represents an alkenyl group containing two or more carbon atoms, B represents a bond or a CO group; A-O independently represents a C₂₋₁₈ oxyalkylene group; R² represents a hydrogen atom or a C₁₋₃₀ hydrocarbon group and m represents an integer of from 0 to 300; and/or
an addition product obtained by the addition of 0-8 moles of an alkylene oxide having 2 to 4 carbon atoms to one equivalent of amino residues in polyamide polyamine obtained by condensation of 1.0 mole of a polyalkylene polyamine, 0.8-0.95 mole of a dibasic acid or an ester of the dibasic acid with a lower alcohol having 1 to 4 carbon atoms, and 0.05-0.18 mole of acrylic acid or methacrylic acid, or an ester of acrylic acid or methacrylic acid with a lower alcohol having 1 to 4 carbon atoms;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):
R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2; and,
when m is 0, esterifying the resulting copolymer with a compound of formula HO-(A-O—)_{z}R², wherein R² represents a hydrogen atom or a C₁₋₃₀ hydrocarbon group and z represents an integer of from 1 to 300.

2. A copolymer according to claim 1 obtainable by polymerizing monomer components comprising:
(a) a compound represented by formula (A1):
Y—B—O—(A-O—)ₘR² (A1)
wherein Y represents an alkenyl group containing two or more carbon atoms, B represents a bond or a CO group; A-O independently represents a C₂₋₁₈ oxyalkylene group; R² represents a hydrogen atom or a C₁₋₃₀ hydrocarbon group and m represents an integer of from 1 to 300; and/or
an addition product obtained by the addition of 0-8 moles of an alkylene oxide having 2 to 4 carbon atoms to one equivalent of amino residues in polyamide polyamine obtained by condensation of 1.0 mole of a polyalkylene polyamine, 0.8-0.95 mole of a dibasic acid or an ester of the dibasic acid with a lower alcohol having 1 to 4 carbon atoms, and 0.05-0.18 mole of acrylic acid or methacrylic acid, or an ester of acrylic acid or methacrylic acid with a lower alcohol having 1 to 4 carbon atoms;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):
R¹¹R¹²C═CR¹³—(CR³R⁴)ₙ-0-CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

3. A copolymer according to claim 1 obtainable by polymerizing monomer components comprising:
(a) a compound represented by formula (A1):
Y—B—O-(A-O—)ₘR² (A1)
wherein Y represents an alkenyl group containing two or more carbon atoms, B represents a bond or a CO group; A-O independently represents a C₂₋₁₈ oxyalkylene group; R² represents a hydrogen atom or a C₁₋₃₀ hydrocarbon group and m represents an integer of from 1 to 300;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):
R¹¹R¹²C═CR¹³—(CR³R⁴)n-O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

4. A copolymer according to claim 1 obtainable by polymerizing monomer components comprising:
(a) a compound represented by formula (A2):
CH₂═CH—CH₂—O-(A-O—)ₘR² (A2)
wherein A-O independently represents a C₂₋₁₈ oxyalkylene group; R² represents a hydrogen atom or a C₁₋₃₀ hydrocarbon group and m represents an integer of from 1 to 300;
(b) an unsaturated dicarboxylic acid or a salt thereof or an anhydride of an unsaturated dicarboxylic acid; and
(c) a compound represented by formula (C):
R¹¹R¹²C═CR¹³—(CR³R⁴)n-O—CO—CH═CH—COOR¹⁶ (C)
wherein R³ and R⁴ independently from each other are hydrogen or an alkyl group, wherein one of _{R}¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

5. A copolymer according to claim 1 obtainable by polymerizing monomer components comprising:
(a) a compound represented by formula (A2):
CH₂═CH—CH₂—O-(A-O—)ₘR² (A2)
wherein A-O independently represents a C₂₋₁₈ oxyalkylene group; R² represents a hydrogen atom or a C₁₋₃₀ hydrocarbon group and m represents an integer of from 1 to 300;
(b) an unsaturated monocarboxylic acid or a salt thereof; and
(c) a compound represented by formula (C):
R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

6. A copolymer according to claim 1 obtainable by polymerizing monomer components comprising:
(a) a compound represented by formula (A4):
Z—O-(A-O—)ₘR² (A4)
wherein Z represents an acroyl group or a methacroyl group; A-O independently represents a C₂₋₁₈ oxyalkylene group; R² represents a hydrogen atom or a C₁₋₃₀ hydrocarbon group; m represents an integer of from 1 to 300;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):
R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

7. A copolymer according to claim 1 obtainable by polymerizing monomer components comprising:
(a) a compound represented by formula (A5):
R²¹R²²C═CR²³—X—O-(A-O—)ₘR² (A5)
wherein R²¹, R²² and R²³ independently from each other represent hydrogen or methyl, X represents CH₂, CH₂CH₂, CO or a bond; A-O independently represents a C₂₋₁₈ oxyalkylene group; R² represents a hydrogen atom or a C₁₋₃₀ hydrocarbon group; m represents an integer of from 1 to 300;
(b) a compound represented by formula (B5):
R²⁴HC═CR²⁵COOM³ (B5)
wherein R²⁴ represents hydrogen or COR²⁶, R²⁵ represents hydrogen or methyl, R²⁶ represents OW, and M³ and M⁴ independently from each other represent hydrogen, an alkaline metal atom, an earth alkaline metal atom, ammonium or an organic ammonium group; or wherein M³ and R²⁶ together represent a bond; and
(c) a compound represented by formula (C):
R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2.

8. A copolymer according to claim 1 obtainable by polymerizing monomer components comprising:
(a) a compound represented by the following formula:
Y—B—OH or Y—B—O-Alkyl
wherein Y represents an alkenyl group containing two or more carbon atoms and B represents a CO group; and
(c) a compound represented by formula (C):
R¹¹R¹²C═CR¹³—(CR³R⁴)ₙ—O—CO—CH═CH—COOR¹⁶ (C)
wherein R³ and R⁴ independently from each other are hydrogen or an alkyl group, wherein one of R¹¹, R¹² and Rⁿ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2; and,
esterifying the resulting copolymer with a compound of formula HO-(A-O—)ₘR², wherein A-O independently represents a C₂₋₁₈ oxyalkylene group; R² represents a hydrogen atom or a C₁₋₃₀ hydrocarbon group and m represents an integer of from 1 to 300.

9. A copolymer according to claim 1 obtainable by polymerizing monomer components comprising:
(a) a compound represented by the following formula:
Y—B—OH or Y—B—O-Alkyl
wherein Y represents an alkenyl group containing two or more carbon atoms and B represents a bond or a CO group;
(b) an unsaturated monocarboxylic acid or a salt thereof, or an unsaturated dicarboxylic acid or a salt thereof or an anhydride of an unsaturated dicarboxylic acid; and
(c) a compound represented by formula (C):
R¹¹R¹²C═CR¹³—(CR³R⁴)n-O—CO—CH═CH—COOR¹⁶ (C)
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, wherein R¹⁶ is hydrogen, an alkaline metal atom, an earth alkaline metal atom, ammonium or an organic ammonium group and wherein n is 1 or 2; and,
esterifying the resulting copolymer with a compound of formula HO-(A-O—)ₘR², wherein A-O independently represents a C₂₋₁₈ oxyalkylene group; R² represents a hydrogen atom or a C₁₋₃₀ hydrocarbon group and m represents an integer of from 1 to 300.

10. The copolymer according to claim 1, wherein monomer component (c) is a monoester obtainable by esterification of at least one acid selected from the group consisting of maleic acid and fumaric acid, with at least one alcohol selected from the group consisting of allyl alcohol, methallyl alcohol and isoprenyl alcohol.

11. The copolymer according to claim 1, wherein monomer component (c) is allyl maleate.

12. The copolymer according to claim 1, wherein monomer component (b) is acrylic acid, methacrylic acid, or maleic acid or a salt thereof or maleic anhydride.

13. A water soluble polymer comprising the following monomer unit: 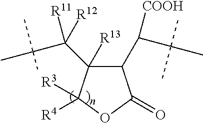
wherein R³ and R⁴ independently from each other are hydrogen or an alkyl group, wherein one of R¹¹, R¹² and R¹³ is methyl and the other two groups are hydrogen or wherein all of R¹¹, R¹² and R¹³ are hydrogen, and wherein n is 1 or 2.

14. A water soluble polymer comprising the following monomer unit:

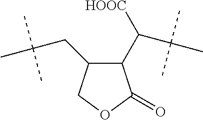

15. A water-soluble dispersant for mineral systems including binders, ceramics, clays, pigments, aggregates and fillers, comprising a copolymer or polymer according to claim 1.

16. A dispersant for inorganic binders comprising a copolymer or polymer according to claim 1.

17. A cement dispersant comprising a copolymer or polymer according to claim 1.

18. A process for the production of a copolymer according to claim 1, wherein a compound of formula Y—B—OH or a compound of formula Y—B—O-Alkyl is polymerized with monomer (b) and monomer (c) and the resulting polymer is esterified with a compound of formula HO-(A-O—)ₘR², wherein m represents an integer of from 1 to 300.
